(19) United States
(12) Patent Application Publication
(10) Pub. No.: US 2006/0267300 A1
(43) Pub. Date: Nov. 30, 2006

(54) Waste and recycle containers

(76) Inventor: Larry Shea, Bensalem, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/444,748

(22) Filed: May 31, 2006

Related U.S. Application Data
(60) Provisional application No. 60/685,991, filed on May 31, 2005.

(51) Int. Cl. B62D 39/00

(52) U.S. Cl. 280/33.998

(57) ABSTRACT

A pair of portable storage containers, especially containers for household trash and for recyclable materials respectively, are interconnectable and movable as a unit as, for example, between a storage location adjacent a home and a curbside pick up site. As disclosed, the containers are adapted to be stacked on top of one another and interlocked when stacked by interlocking fasteners. As shown, the fasteners are of a bayonet type comprising integrally molded headed studs projecting from the bottom of the trash container and slots formed in a flanged support surface surrounding the opening in the other container. The studs fit within enlarged end portions of the slots, and upon relative movement, the studs move into a narrower end portion in which the two containers are locked together. Both containers have wheels for mobility either as a stack or separately.

### FIELD OF THE INVENTION

This invention relates to portable, connectible storage containers and especially to containers for materials such as household trash connectible to containers such as are intended for use for recyclable materials.

### BACKGROUND OF THE INVENTION

In households across the country, transporting trash containers and recycle bins from residence to roadside is a regular chore that most householders, especially senior citizens, do not look forward to. This is particularly the case when multiple containers laden with heavy materials must be transported.

With the advent of recycling programs, the problem for the householder has become even more cumbersome since the separate containers require multiple trips to the roadside on days when recyclables and regular trash are scheduled for pickup. As a consequence, the prior art reflects a variety of solutions designed to simplify the trash transport problem for the householder.

Exemplary of the known prior art is U.S. Pat. No. 6,607,088. This patent discloses a portable waste container having attachment brackets which fit over the edge of the opening of the trash container and have a support frame attached to the brackets for receiving a container such as a recycle bin, thereby allowing for transport of the waste container and bin in a single trip between the trash storage location and a roadside collection site.

A similar system is disclosed in U.S. Pat. No. 5,713,499 in which brackets 30 are attached to a waste container. A support for a recycle bin includes hooks 22 which attach to the brackets 30 and support the recycle bin. Adjustable hooks 24 fit over the edge of the opening of the recycle bin to hold it in place. The waste container is provided with wheels so that both containers can be transported to and from the trash pickup point as a unit.

U.S. Pat. No. 5,878,904 illustrates a trash can provided with divider structure for fitting a plurality of separate compartments for separating and storing recyclable materials. The divider structure defines a central aperture which permits the deposit of recyclable metal cans or other material into the bottom of the trash can. The divider structure is provided with lip portions which fit over the rim surrounding the opening at the top of the trash can.

U.S. Pat. No. 6,378,721 discloses a compartmentalized trash can includes liner bags which fit within a flange at the opening of the container. The liner bags fit within each of the subdivisions of the trash can.

### SUMMARY OF THE INVENTION

The present invention comprises multiple containers, one of which is intended to be used for receiving materials such as household trash and the other of which is intended for receiving recyclable items. Preferably, the container for recyclables is attachable to the bottom of the trash container by manually connectable and readily disconnectable devices when desired by the householder. Two or even more similarly equipped recycle containers may be stacked one on top of the other and connected using the same type of connecting devices with the topmost recycle container connected to the bottom of the trash container and at least one extra recycle container attached to the bottom of the first. To maximize portability, each of the containers, including the trash container and all recycle containers, is provided with wheels allowing for wheeled transport of one or all of the containers as a unit. Interlocking connector means are provided for fastening one container in a stack to the next.

### BRIEF DESCRIPTION OF THE DRAWINGS

FIG. 1 is a perspective view illustrating the preferred embodiment of the invention comprising a trash container having one recycle container attached to its bottom surface;

FIG. 2 is a view similar to FIG. 1 in which the trash container is shown elevated and separated from the recycle container;

FIG. 3 is a sectional view taken along lines 3-3 of FIG. 1;

FIG. 4 is sectional view taken along lines 4-4 of FIG. 3; and

FIG. 5 is a sectional view similar to FIG. 4 illustrating a trash container and recycle container each having a rectangular cross sectional configuration.

### DETAILED DESCRIPTION OF THE EMBODIMENTS

With reference first to FIGS. 1-4, a preferred application of the invention is shown wherein a conventional trash container 10 is supported on top of a container for recyclables 12. Usually, the trash container has a lid, not shown.

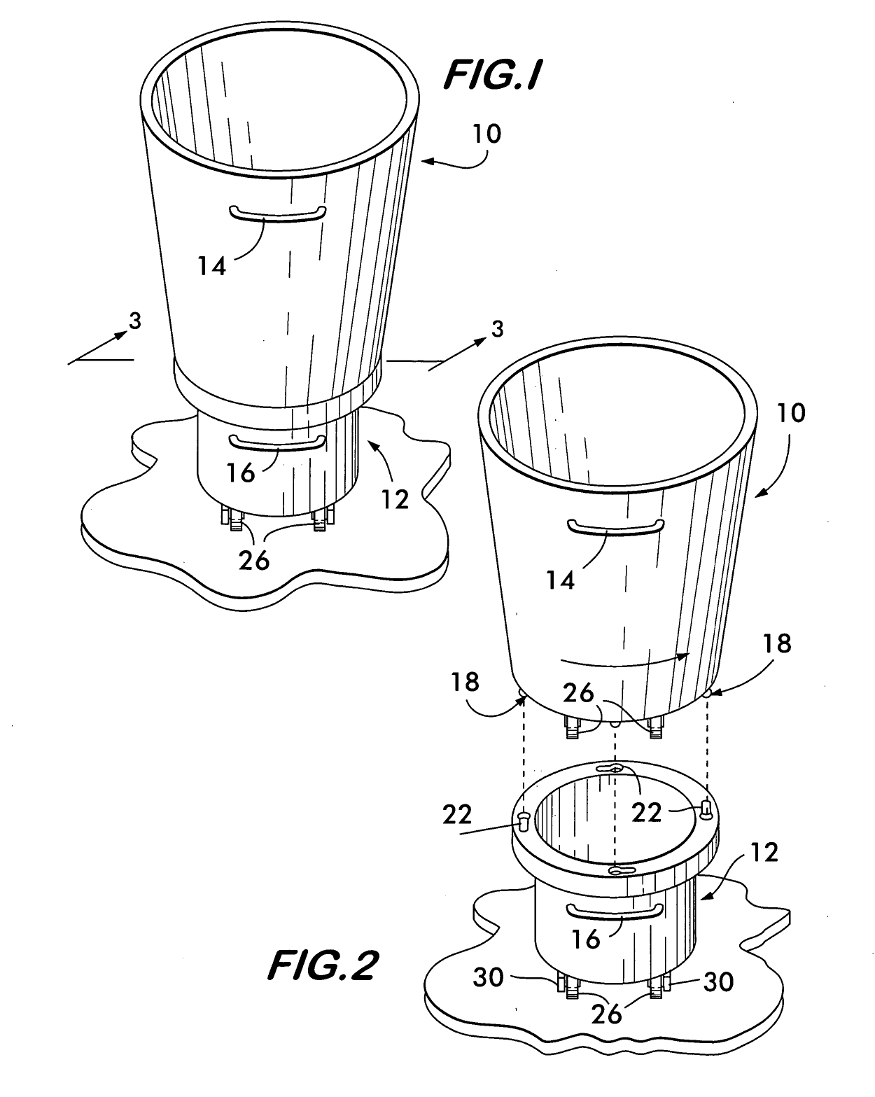

As is typical in the art relevant to such containers, the trash container 10 is provided with a pair of oppositely disposed handles, one of which is shown at 14 in FIG. 1. Recycle container 12 may also be provided with one or more similarly situated handles, one of which is shown at 16 in FIGS. 1 and 2.

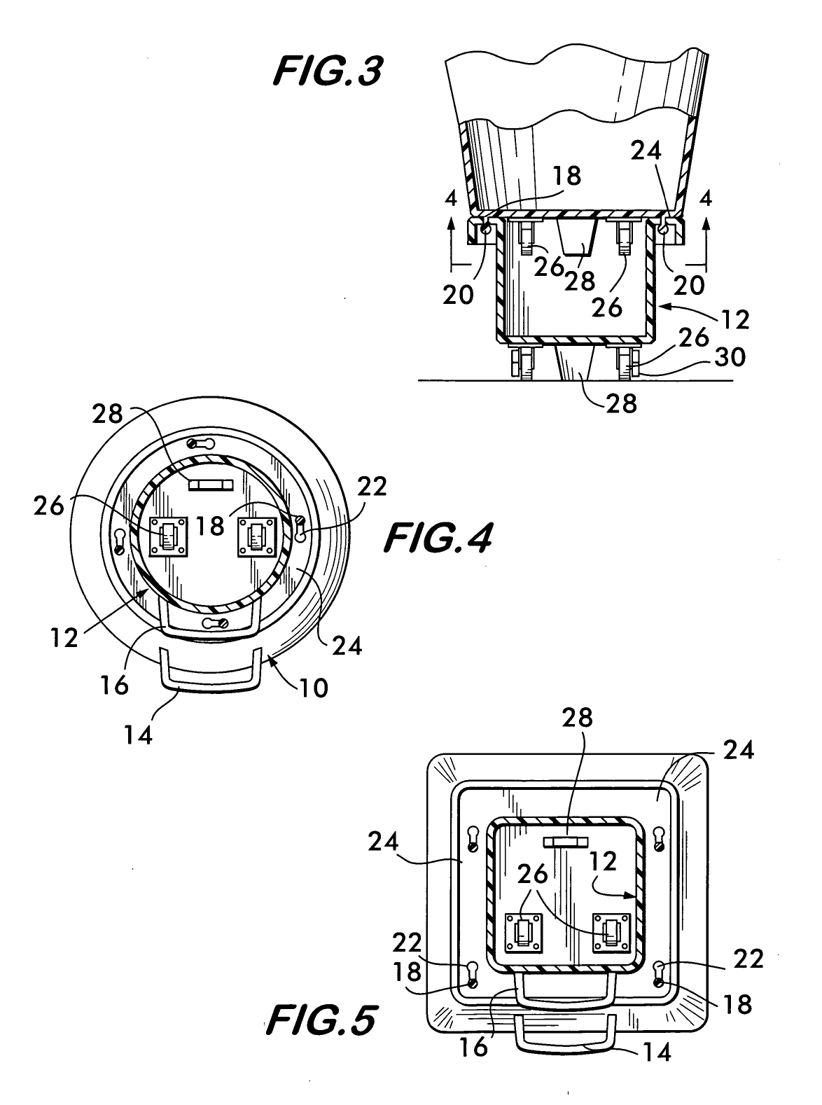

As best seen in FIGS. 3 and 4, interconnectable attachment devices are preferably formed as projecting lugs or pins 18 having enlarged heads 20 project downwardly from the bottom surface of trash container 10. The heads of lugs 18 fit within enlarged end portions of slots 22 in recycle container 12. For this purpose, the slots 22 are provided within a radially extending support flange 24 outwardly extending from the upper surface of the sidewalls of container 12. As should be understood, the enlarged heads 20 fit within the enlarged portions of slots 22 and lock the two containers in place upon relative rotation of the trash container 10 and the recycle container 12 to a position in which the heads are retained within the narrower slot portions.

Each of the containers is preferably provided with a pair of casters 26 having rotatable wheels of a type conventional in the art. A downwardly extending foot 28 located on the bottom of each container in offset relation to the axis of the caster wheels provides stability for each container when it is not being moved. Foot 28 may be molded directly onto the bottom of each container in cases where the containers are formed of molded plastic material using techniques well known in the art. The casters and foot of the upper containers in a stack are positioned so that they fit within the supporting container when the stock is assembled. If desired, in order to provide stability when the containers are not to be moved, the castors 26 may be provided with locking devices 30 which are of known type rotatable between positions in which the wheels are free for rotation and the wheels are locked.

FIG. 5 is a view similar to FIG. 4 illustrating the connection of a rectangular recycle container to the bottom of a rectangular trash container. In FIG. 5, like numerals are used to identify like parts identified in FIGS. 1-4. According to FIG. 5, the recycle container has four slots formed in its flange 24, all extending in the same direction. The enlarged heads of lugs 18 fit within the enlarged portion of the slots 22. When they are so fitted, the two containers are then shifted lengthwise relative to one another so that the lugs move into the narrow portion of the slots, thereby locking the containers together.

In use, in the case of both embodiments, it is contemplated that the trash container and the recycle container will be separated for the receipt of trash and recyclable materials. When trash and recyclables are to be moved to a trash collection site, the trash container is placed on top of the recycle container with the enlarged heads of the lugs 18 aligned with the enlarged portions of the slots in the flange 24 of recycle container 12. When the lugs are fitted through the enlarged portions of the hole, relative lateral movement of the two containers (towards the bottom edge of the drawing sheet) locks them together for transport to the collection site. At the collection site, it is contemplated that the two containers will be separated by the householder for collection of their contents by the trash and/or recyclable material collectors.

Salient features of the invention are the use of interconnectable containers transportable as a unit and provided with easy to use connecting parts which simplify the chore of moving trash and recyclables to the roadside collection site. The containers are preferably all provided with wheels to maximize the ease with which any number of containers may be moved. The containers are simple in construction and simple for a householder to interconnect and disconnect.

If desired that more than one recycle container be moved to the roadside with another as a unit, either with or without a trash container, each of the recycle containers could be provided with a flange similar to flange 24 extending from the bottom radially outwardly from the container, in which case projecting lugs would also be provided extending downwardly from each of the flanges extending from the bottoms of each recycle container.

What is claimed is:

1. In combination, a pair of interconnectable containers, a first one of said containers being adapted for containment of household trash, the second being adapted for containment of recyclable items, said containers each having a base and one having a support flange laterally positioned to support the base of the other container, wherein the base of the first container and the flange have interengagable fastening parts, the parts being relatively movable into interlocking relationship when the base of the first is placed in supporting relationship on the support flange.

2. The combination of containers of claim 1 further comprising ground-engaging wheels on the container having the support flange.

3. The combination of containers of claim 2, wherein both containers have ground-engaging wheels.

4. The combination of containers of claim 3, wherein the wheels of the first of said containers are spaced relative to the other container to fit within the other container when the two containers are interconnected.

5. The combination of containers of claim 1, wherein the fastening parts comprise projecting members having relatively large head portions and shank portions narrower than the head portions for support of the head portions on one of said containers and slots on the other container, the slots corresponding to the projecting members and being positioned to receive the projecting members, the slots each having an end portion dimensioned to receive the head portions of the projecting members and a narrower portion extending from the end portions, the narrower portions being narrower than the head portions so as to prevent separation of the containers upon relative movement of the shank portions with respect to the slots.

6. The combination of containers of claim 1, wherein the container adapted for containing household trash has a circular base and the other container has a circular support flange.

7. The combination of containers of claim 1, wherein the container adapted for containing household trash has a rectangular base and the other container has a rectangular support flange, the slots of the recycle container extending parallel to opposing edges of the support flange.

8. In combination, a pair of interconnectable stackable containers, said containers each having a base and one having a surrounding support flange relatively positioned to support the base of the other, wherein the base of the supported container and the flange of the supporting container have interengagable fastening parts, the parts being relatively slidably moveable into interlocking relationship when the base of the supported container is resting on the support flange of the supporting container.

9. The combination of claim 8, wherein the supporting container is supported on a pair of support wheels.

10. The combination of claim 9, further including manually lockable devices for manually locking said support wheels against rotation.

11. The combination of claim 10, further including a support foot projecting downwardly from the base of the supporting vessel and offset from the axis of rotation of the support vessel.
